(19) United States
(12) Patent Application Publication
(10) Pub. No.: US 2005/0268803 A1
(43) Pub. Date: Dec. 8, 2005

(54) Clamping device for clamping a flexible covering of a cylinder of a printing press

(76) Inventors: Andreas Zahnd, ZOLLIKOFEN (CH); Andre Kolzem, Bern (CH)

Correspondence Address: MCGLEW & TUTTLE, PC, P.O. BOX 9227, SCARBOROUGH STATION, SCARBOROUGH, NY, 10510-9227, US

(21) Appl. No.: 10/526,452

(22) PCT Filed: Sep. 24, 2003
(86) PCT No.: PCT/CH03/00638

§ 371 Date: Mar. 2, 2005

(30) Foreign Application Priority Data
Sep. 26, 2002 (DE) 102 44 945.7
Sep. 26, 2002 (DE) 102 44 944.9

(51) Int. Cl. B41F 1/28

(52) U.S. Cl. 101/415.1

(57) ABSTRACT

A clamping device is provided for clamping a flexible packing of a cylinder of a printing press, which cylinder has an axial channel on a jacket surface. The clamping device has a clamping body (10; 20; 25), which forms a clamping gap in the channel (6) with a first opposite surface (4) for at least one end of the packing (2, 3), which end protrudes through a opening (7) of the channel (6). Two channel walls face the first opposite surface (4), and one of which forms a second opposite surface (5) and the other forms a third opposite surface (9). At the surfaces the clamping body (10; 20; 25) is supported touching the wall or walls. At least one clamping body (10; 20; 25) and the opposite surfaces (4, 5, 9) form a spring (10; 20; 14; 15). The force of elasticity of the spring (10; 20; 14; 15) tensions the clamping body (10; 20; 25) and the first opposite surface (4) toward each other in order to clamp the at least one end of the packing (2, 3) with the packing (2, 3) pulled in.

### FIELD OF THE INVENTION

The present invention pertains to a clamping device of a printing press cylinder, which is used to clampingly fasten a flexible packing of the cylinder on the cylinder. The present invention can be used especially in offset printing, preferably in web printing.

### BACKGROUND OF THE INVENTION

A clamping device as the one to which the present invention pertains is needed especially for rubber blanket cylinders and printing form cylinders of rotary printing presses to fasten a rubber blanket or a flexible printing form, which rubber blanket or printing form is tensioned on a jacket surface of the cylinder, on the cylinder while maintaining the tension. The cylinders have one or mostly a plurality of axial channels on their jacket surface, in which channel or channels a clamping device each is formed.

U.S. Pat. No. 5,010,818 discloses a clamping device which comprises a plurality of cylindrical clamping bodies, each of which is directly supported elastically in a nonrigid manner at a coil spring in the radial direction of a printing cylinder. The springs press the clamping bodies radially outwardly against two opposite surfaces formed in a clamping channel, so that a clamping gap can be formed with one of the opposite surfaces or the other as desired. The coil springs are supported radially inwardly at mount bodies, which are arranged in the channel. They are guided in the radial direction over part of their axial lengths. On their rear sides, the clamping bodies have holes, into which the coil springs extend. The clamping device requires a plurality of different components, which are movable in relation to one another and must be arranged in the channel. The coil springs are subject not only to pressure, but also bending during the clamping of a packing.

According to U.S. Pat. No. 4,577,560, a clamping device is formed by two clamping jaws, which enclose a clamping channel between them. One of the clamping jaws is rigidly connected to the cylinder. The other clamping jaw is movable in the circumferential direction of the cylinder, so that the width of the channel measured in the circumferential direction can be changed. When viewed from the opening of the channel, the two clamping jaws form two channel walls, with which the ends of a packing can be brought into contact. A hollow cylindrical spring element or a coil spring is arranged in the lying position in the channel. To pull in the packing, the movable clamping jaw assumes a position in which the channel opening is widest. One end of the packing is hooked into the channel, so that it is in contact with one of the channel walls. The other end of the packing is subsequently hooked in, so that it is in contact with the other of the channel walls. The movable clamping jaw is adjusted toward the other clamping jaw partly in order to tension the packing on the cylinder and partly to press the two ends of the packing against each other in the area of the channel opening and to clamp the packing as a result. With the packing clamped, the spring element is elastically compressed, so that after the clamping jaws have been moved together, it is pressed against the ends of the packing which extend into the channel and prevents the ends of the packing from bulging outwardly at the clamping point, i.e., in the area of the channel opening. The clamping device is complicated. It requires a movable clamping jaw for clamping the ends of the packing and additionally a spring element, which prevents the packing from bulging in the area of the channel opening after the clamping of the ends of the packing. The channel walls are sloped only slightly in relation to the radial direction in order to enable the ends of the packing to be hooked in. The spring element must be so small that it will not be an obstacle during the hooking in.

Another clamping device, which requires an adjustable clamping element, is known from DE 26 20 427 B2. The clamping device comprises a spring strip, which is mounted pivotably in a clamping channel, and a clamping body which is elastic in its material, against which the spring strip is pivoted to clamp two ends of the packing. The spring strip is fastened to a mount body, which has a regular cylindrical shape over part of its circumference. The channel has correspondingly a regular cylindrical shape and forms a bearing shell for the mount body. The mount body is flattened on a front side facing the channel opening. The elastic clamping body lies on the flattened area. The spring strip is pivoted toward one of the two limiting edges of the channel by rotating the mount body. The clamping body is arranged between the spring strip and the corresponding limiting edge. One of two ends of the packing which extend into the channel is clamped in a clamping gap between the clamping body and a channel wall and the other is clamped in a second clamping gap between the clamping body and the spring strip. Due to the pivoting movement of the spring strip, the spring strip and the clamping body are elastically tensioned. The spring strip must be pivoted actively. The clamping device requires a wide channel opening. However, the known problem of channel beat increases with increasing width of the channel opening.

### SUMMARY OF THE INVENTION

One object of the present invention is to provide a clamping device which is simple, makes possible a narrow clamping gap and clamps a packing securely and stiffly.

A clamping device for clamping a flexible packing of a cylinder of a printing press, which cylinder has at least one axial channel on a jacket surface, comprises a clamping body, which is arranged in the channel and forms a clamping gap with a first opposite surface of the channel for at least one end of the packing, which end extends through an opening of the channel. Two ends of the packing are clamped in the clamping gap in most applications. The two ends may be the leading end or the trailing end of a single packing, preferably of a rubber blanket or of a printing form, or the ends of two packings, which span only over part of the circumference of the cylinder. The first opposite surface is faced by two channel walls, one of which forms a second opposite surface and the other a third opposite surface, at which the clamping body is supported by touching the second opposite surface and the third opposite surface.

The clamping device comprises, furthermore, a spring. According to the present invention, this spring forms either the clamping body or at least one of the opposite surfaces or both the clamping body and also at least one of the opposite surfaces. With its force of elasticity, the spring presses the clamping body and the first opposite surface against each other in order to clamp the at least one end of the packing or preferably the two ends of the packing with the packing having been pulled in. Even though it is not absolutely necessary, the clamping body and the first opposite surface are preferably pressed against each other by the force of elasticity already when the packing has not been pulled in. The spring is thus pretensioned in this case. The force of elasticity of the spring, i.e., the rigidity of the spring and optionally a pretensioning force, is selected to be such that the at least one end of the packing or the two ends of the packing can be introduced against the force of elasticity into the clamping gap, preferably manually. The first opposite surface and the clamping body advantageously form a funnel opening toward the opening of the channel and narrowing toward the clamping gap. The clamping body is shaped such that blocking of the end of the packing or of the ends of the packing cannot occur during the introduction into the clamping gap. Tensioning of the clamping device is not necessary, because the clamping device tensions itself by the introduction of the end of the packing or of the ends of the packing into the clamping gap or preferably it tensions itself more strongly in addition to a pretension that was already present before. If the clamping device was not already pretensioned, as preferred, the channel and the clamping body are formed in a close fit, so that the clamping force necessary for clamping the at least one end of the packing will have built up by itself at the latest when the at least one end of the packing extends into or through the clamping gap.

As a result, a self-tensioning clamping device is obtained by means of the spring. Not only a mechanically simple clamping device but also a clamping device that clamps the at least one end of the packing rigidly and therefore securely and in a defined manner is obtained due to the clamping body being supported at channel walls rigidly connected to the cylinder without the intermediary of additional spring elements, e.g., coil springs. No additional mounting means and likewise no adjusting means is required, even though such a device may definitely be present to facilitate the pulling in at inaccessible points or the removal of a packing.

In a preferred first embodiment, the clamping body forms the spring. The clamping body is elastic in its material in a first variant and has an elastic shape in a second variant. It may also be elastic in its material and in its shape in combination.

In the variant in which the clamping body is elastic in its material, it may be formed in its entirety from an elastic material, e.g., an elastomer or rubber, or preferably as a composite. As a composite, it has an elastic material at least on a surface area forming the clamping gap. As a composite, it preferably has a jacket made of an elastic material over its circumference. The composite has the advantage that another material, which has a higher specific gravity than the elastic material, may also be used to form the clamping body besides the elastic material. However, the heavier the clamping body, the stronger is the clamping force exerted by it during the rotation of the cylinder, because the portion of the clamping force resulting from the centrifugal force increases with increasing speed of the cylinder, and the centrifugal force is proportional to the mass of the clamping body. An especially preferred composite forming the clamping body therefore has a core consisting of a material with an advantageously high specific gravity, e.g., steel, and circumferentially a jacket made of an elastic material. The core and the jacket are preferably connected to each other in substance; however, a frictionally engaged and/or positive-locking connection alone or combined with a connection in substance is also conceivable. The hardness of the elastic material should be at least 60 Shore, but, on the other hand, it should not exceed 80 Shore.

In the variant in which the clamping body is elastic due to its shape, the clamping body forms an elastic arc, which is open on a side facing away from the first opposite surface. By introducing the end of the packing or the ends of the packing into the clamping gap, the arc is elastically deformed, and it will subsequently clamp the packing with its restoring force of elasticity. The arc preferably extends at least to the second opposite surface. The second opposite surface is shaped and oriented in preferred embodiments such that it can form a second clamping gap with the clamping body, so that the end of the packing or the ends of the packing can be clamped between the clamping body and either the first opposite surface or the second opposite surface, depending on the direction of rotation of the cylinder. The clamping body that is elastic due to its shape preferably ends in support feet at the two ends of the elastic arc, the support feet being in contact with the third opposite surface, preferably such that they can slide off at the third opposite surface during the inward spring deflection of the arch. Furthermore, the support feet ensure that the arc will maintain its angle of rotation position in the channel and that its surface, which is curved convexly to the first opposite surface and preferably also to the second opposite surface, will always be located opposite the corresponding opposite surface.

In a preferred second embodiment, the spring forms one of the opposite surfaces. The spring may be, e.g., a coating of an elastic material, e.g., an elastomer coating or a rubber coating, which is fastened to the channel wall in question. More preferably, the spring is formed by an insert, which is inserted into the corresponding channel wall in a depression formed specifically for the insert. The insert preferably consists of an elastic material, e.g., an elastomer or rubber. However, it is also conceivable to design the opposite surface that is elastic in its material as a spiral spring with a clamped end and a free end or two clamped ends. The insert forms a flat surface with the channel wall into which it is inserted. A coating or preferably insert that is elastic in its material should have a hardness of at least 60 Shore; on the other hand, the hardness should not exceed 80 Shore.

The coating or insert may be optionally provided with a wear-registrant surface. For example, a thin but nevertheless rigid metal plate may be fastened to the surface of the coating or insert pointing into the channel, so that the coating or insert will undergo a uniform inward spring deflection over its entire surface. Such a layer should likewise end flat with the surrounding channel wall. If the coating or insert does not have a solid surface, it may be advantageous for it to drop slightly toward the inside of the channel on its surface pointing into the channel, i.e., to be convex toward the end of the packing in order to facilitate the introduction of the end of the packing touching it.

Even though it is possible, in principle, for both the clamping body and at least one of the opposite surfaces to form a spring each and to deflect the plurality of springs thus formed inwardly only together by the thickness of the at least one end of the packing, the spring is formed in preferred embodiments either only by the clamping body or only by at least one of the opposite surfaces. If the clamping body is the spring, the opposite surfaces are preferably not nonrigid, but hard. Conversely, if the spring is formed by at least one of the opposite surfaces, the clamping body is advantageously hard.

The clamping device advantageously permits the clamping of at least one end of the packing on both sides of the channel as desired, so that it is invariant in respect to the direction of rotation. The channel and the clamping device formed therewith are preferably symmetrical for this purpose in relation to a radial, which points through the opening of the channel toward the axis of rotation of the cylinder. Not only the first opposite surface, but also the second opposite surface do point in such a design radially inwardly from the channel opening in order to create a second clamping gap for the optional clamping of the packing combined with the clamping body. If the third opposite surface faces, as is preferred, both the first and second opposite surfaces, it would be sufficient for the third opposite surface to be elastic. However, the two opposite surfaces that form the clamping gap as desired, i.e., the first opposite surface and the second opposite surface, are preferably formed by a spring each as described above.

A plurality of separate clamping bodies of the type described may be arranged axially to one another in the channel. A plurality of clamping bodies on a shaft or axis may also be connected to one another. Only a single clamping body is arranged in the channel in preferred embodiments. If a plurality of clamping channels are formed in the cylinder, what was stated above in connection with one of the channels also applies to the additional channels.

The subclaims and their combinations also describe advantageous features of the present invention. The features disclosed by the claims and the above explanations mutually complement each other in an advantageous manner.

Exemplary embodiments of the present invention will be described below on the basis of figures. Features disclosed in the exemplary embodiments represent advantageous variants of the subjects of the claims as well as of the above-described embodiments individually and in any combination of features.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

FIG. 1 shows a clamping device according to of a first exemplary embodiment with a clamping body that is elastic in its material;

FIG. 2 is a partially cutaway sectional view of a clamping device according to a second exemplary embodiment with a clamping body that is elastic in its material;

FIG. 3 is a partially cutaway sectional view of a clamping device according to a third exemplary embodiment with a clamping body that is elastic due to its shape;

FIG. 4 is a partially cutaway sectional view of a clamping device according to a fourth exemplary embodiment with an insert that is elastic in its material in a channel wall;

FIG. 5 is a partially cutaway sectional view of a clamping device according to a fifth exemplary embodiment with an insert that is elastic in its material in a channel wall;

FIG. 6 is a partially cutaway sectional view of a clamping device according to a sixth exemplary embodiment with two inserts that are elastic in their material and are inserted into two channel walls; and

FIG. 7 is combined partial views of a clamping body in a clamping channel of a cylinder.

### DESCRIPTION OF THE PREFERRED EMBODIMENT

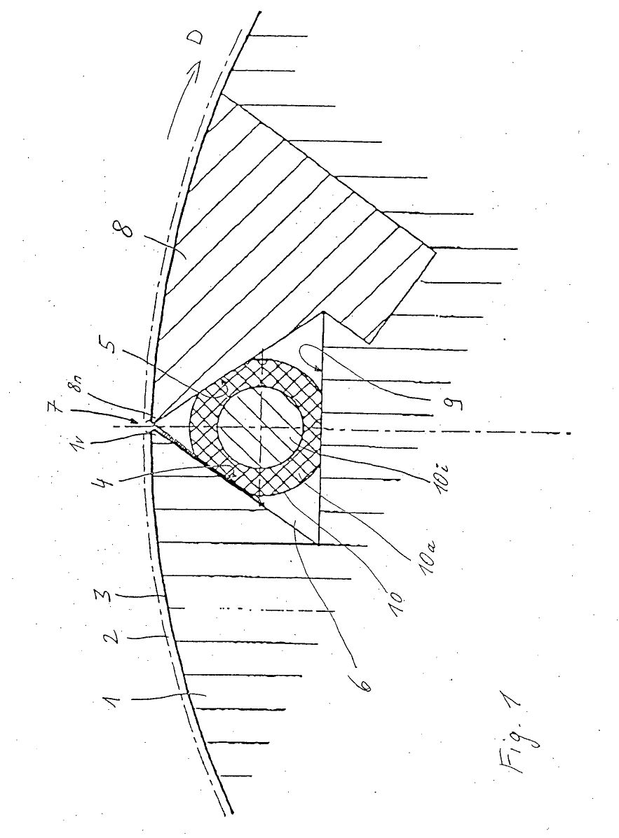

Referring to the drawings in particular, FIG. 1 shows a near-surface part of a printing cylinder 1 of a web-fed rotary printing press for the offset printing of large newspaper editions. The cylindrical surface of the printing cylinder is covered with a flexible packing. The flexible packing is a rubber blanket 2, which is vulcanized or bonded to a flexible plate 3. The printing cylinder is correspondingly a rubber blanket cylinder. To span the flexible plate 3 with the rubber blanket 2 on the surface, the two free ends of the flexible plate 3 are pushed into a clamping channel 6 and clampingly fastened in the channel 6 by means of a clamping device. The clamping device is formed with channel walls of the channel 6. The two clamped ends do not need be the ends of the same plate, and in many applications, indeed they are not. Thus, it is rather common in the case of, e.g., plate cylinders to span two printing form plates one after another over the circumference of the cylinder. A leading end of one plate and a trailing end of the other plate extend into the same clamping channel 6 in such a case.

The channel 6 extends axially, i.e., in parallel to an axis of rotation D_{Z} of the cylinder 1, in a near-surface area of the cylinder and forms a narrow channel opening 7 directly at the surface. The channel opening 7 is limited by two limiting edges, namely, a limiting edge 1v that is a leading edge in the direction of rotation D of the cylinder 1, and a trailing limiting edge 8n. The limiting edges 1v and 8n are located axially in parallel opposite each other in the circumferential direction. The channel 6 widens in its cross section from the limiting edges 1v and 8n on both sides of a radial R extending through the opening 7 to the axis of rotation D_{Z} of the cylinder 1. The opening 7 and the adjoining channel walls 4 and 5 limiting the channel 6 are axially symmetrical to the radial R in the cross section. The ends of the flexible plate 3 which are introduced into the channel 6 extend beyond the rubber blanket 2. The rubber blanket 2 itself is not introduced into the channel 6, but it forms a narrow slot above the channel opening 7 or it preferably abuts against itself (or the next rubber blanket 2) above the channel opening 7.

The clamping device for clamping the ends of the packing 2, 3 is formed by a clamping body 10 arranged in the channel 6 combined with channel walls defining the channel. The channel walls are the channel walls 4 and 5 and another channel wall 9, which form an opposite surface each for the clamping body 10. The clamping body 10 is supported directly on these channels walls 4, 5 and 9, which enclose the channel 6 between them. The channel walls 4 and 9 are formed directly by the cylinder 1 itself. The channel wall 5 forms a filler 8, which is firmly, i.e., nonmovably connected, e.g., screwed to the cylinder 1.

The channel wall 4 extends flat from the channel wall 9 to the limiting edge 1v. The channel wall 5 extends flat from the channel wall 9 to the limiting edge 8n. The channel walls 4 and 5 form the same angle, which should be at least 30° and at most 45°, obliquely in relation to the radial R.

The clamping body 10 has a regular cylindrical shape. It is a composite body with a core 10i made of a core material and a jacket 10a made of a jacket material. The core material has a higher specific gravity or a higher specific density than the jacket material. The jacket material is elastic and may be, e.g., rubber or preferably a plastic, i.e., an elastomer. It has a hardness of 70±10 Shore, the center value or values closer to the center value of 70 Shore being preferred.

The clamping body 10 is directly supported at the channel walls 4, 5 and 9, i.e., it touches with its surface one opposite surface each formed by the channel walls 4, 5 and 9. The opposite surface formed by the channel wall 4 will hereinafter be called the first opposite surface 4, the opposite surface formed by the channel wall 5 the second opposite surface 5, and the opposite surface formed by the channel wall 9 the third opposite surface 9. The support points of the clamping body 10 formed by the opposite surfaces 4, 5 and 9 are arranged distributed over the circumference of the clamping body 10. The total of three support points have an angular distance of less than 180° from one other in pairs, which already follows from the advantageous triangular shape of the channel 6 selected in the exemplary embodiment. It is especially advantageous for two adjacent support points to have the same angular distance, as in the exemplary embodiment.

Depending on the direction of rotation D of the cylinder 1, the clamping body 10 forms a clamping gap for the ends of the packing 2, 3 either with the first opposite surface 4 or with the second opposite surface 5. In the case of the direction of rotation D assumed in the exemplary embodiment, the clamping gap is formed between the clamping body 10 and the first opposite surface 4. In the case of the opposite direction of rotation, the clamping gap is formed in the same manner between the clamping body 10 and the second opposite surface 5. Due to its round surface, the clamping body 10 forms a funnel with the first opposite surface 4, which funnel opens toward the channel opening 7 and facilitates the introduction of the ends of the packing 2, 3. The funnel is shaped such that there is no risk for blocking during the introduction of the ends of the packing. It is advantageous for this for the surface of the clamping body forming the clamping gap to have a large radius of curvature. If the clamping body 10 has a circular cross section, as is preferred and designed in all exemplary embodiments, this means that it should have a large external diameter. If not, a small cross section of the channel 6 is advantageous. The width of the channel opening 7, which cannot be changed any longer after the filler 8 has been inserted, should be as small as possible in order to minimize the cylinder beat.

The clamping body according to the present invention, e.g., that according to the first exemplary embodiment and those according to the other exemplary embodiments, has a radius of curvature of at least 7 mm and preferably at least 10 mm on its surface forming the clamping gap. The upper limit for the radius of curvature is less critical. However, the radius of curvature should not be greater than 20 mm.

The jacket 10a has a sufficient thickness, so that it can perform an inward spring deflection by the sum of the thicknesses of the two ends of the packing 2, 3 due to the elasticity of its material as seen over the entire circumference of the clamping body 10. Besides the elastic jacket 10a, the clamping device according to the first exemplary embodiment has no other possibilities of performing an inward spring excursion, because the support points for the clamping body 10 are formed rigidly directly by the channel walls, namely, the opposite surfaces 4, 5 and 9. The clamping body 10 should have the highest possible mass and therefore the highest possible percentage of core material to increase the clamping force with the cylinder rotating. As a result, the jacket 10a preferably has a uniform thickness of at least 3 mm and at most 7 mm over its circumference. In the preferred dimensioning example, the jacket 10a has a thickness of 5 mm and the core has a diameter of 15 mm.

Based on the rotational symmetry of the clamping body 10 and the support of the clamping body 10 in the channel 6, the clamping body 10 can rotate in the channel 6 around its longitudinal axis D_{K} despite its jacket 10a, as a result of which the introduction of the ends of the packing 2, 3 into the clamping gap and the removal are facilitated. However, the actual performance of a rotary movement is otherwise not necessary. The ends of the packing 2, 3 can also be introduced and removed with the clamping body 10 not rotating.

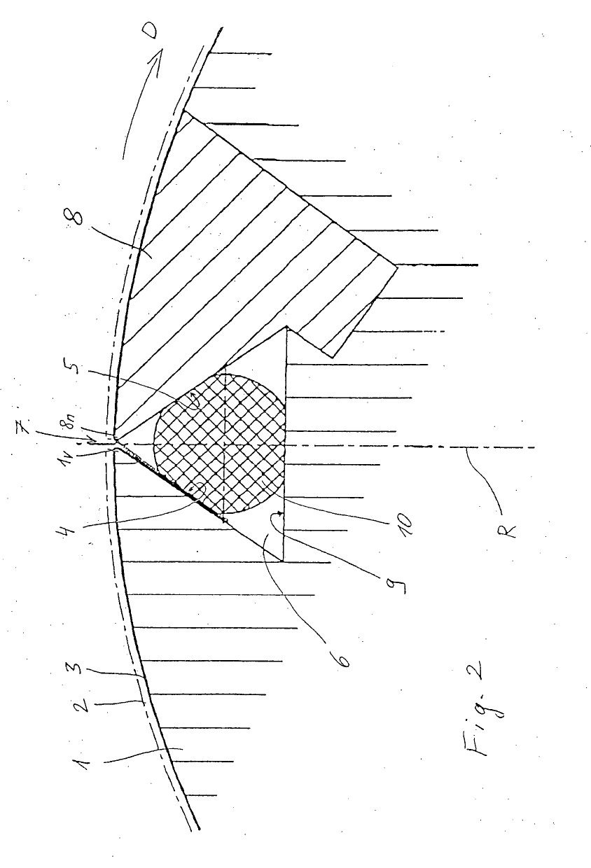

The clamping device shown in FIG. 2 comprises a clamping body 10, which is formed as a solid cylinder from an elastic material, e.g., rubber or an elastomer. The elastic material may be the same material as that of the jacket 10a in the first exemplary embodiment. The statements made in connection with the first exemplary embodiment also apply.

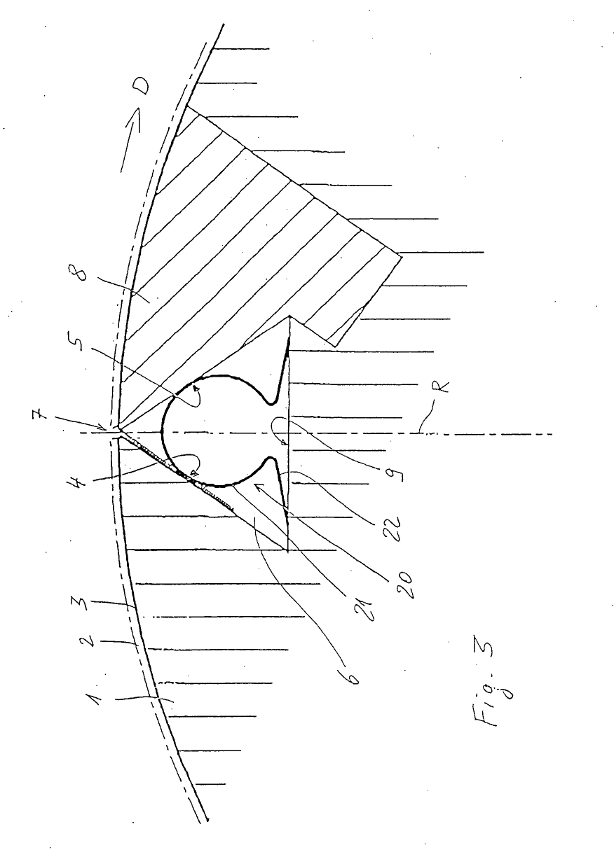

FIG. 3 shows a clamping device according to a third exemplary embodiment. The spring necessary for clamping the ends of the packing 2, 3 is formed by a clamping body 20 arranged in the channel 6 in this clamping device as well. The cylinder 1, the filler 8 and the channel 6 correspond to the first exemplary embodiment and the second exemplary embodiment.

However, contrary to the first and second exemplary embodiments, the spring formed by the clamping body 20 is not elastic in its material. Its spring property is based on elasticity due to shape. It has a cross section essentially in the shape of a Greek “Ω” with an elastic arc 21 and two support feet 22. The arc 21 extends over the first opposite surface 4 and the second opposite surface 5 and is open toward the third opposite surface 9. The essentially regular cylindrical arc 21 extends over the greatest part of the 360° of a closed arc. The two ends of the arc 21, i.e., the two transition areas, in which the arc 21 passes over into the two support feet, are located at a closely spaced location from the opposite surface 9. The support feet 22 are in contact with the opposite surface 9 only with their tapering ends. The support feet 22 end in front of the inner edges of the channel 6, which are formed by the opposite surface 9 with one of the opposite surfaces 4 and 5 each. The support feet 22 can thus slide to and fro along the opposite surface 9, which is advantageous for the inward spring excursion of the clamping body 20. The clamping body 20 can therefore perform an inward spring excursion partly due to a movement of the two ends of the arc 21 toward each other and partly due to a spring movement of the arc 21 as a whole toward the opposite surface 9. The spring movement that actually becomes established during the clamping of the ends of the packing 2, 3 follows from the superimposition of two possibilities of inward spring excursion. Compared with a closed spring arc or a spiral spring, the elastic behavior of the clamping body 20 forming an open spring can be better adapted to the function.

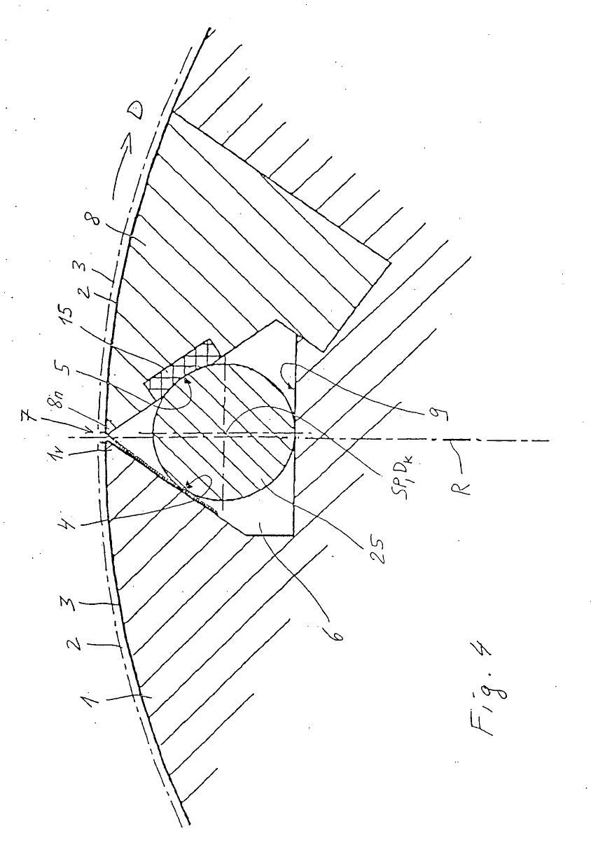

FIG. 4 shows a clamping device according to a fourth exemplary embodiment. In the fourth exemplary embodiment, a spring 15 forms directly the second opposite surface 5, which is located opposite the clamping gap in the circumferential direction of the cylinder 1. The channel 6 according to the fourth exemplary embodiment is polygonal with a total of five channel walls, each of which is flat, but the support points and consequently the opposite surfaces 4, 5 and 9 with the identical numbers for the clamping body 25 are again formed only by the channel walls 4, 5 and 9. A triangular cross section of the channel 6 may basically also be assumed in the fourth exemplary embodiment. The design of the channel 6 with more than two inner edges in the cross section facilitates the manufacture, because the inner edges to be formed by machining the material may be rectangular or blunt. However, this alone does not result in any difference for the function of the clamping device from the first, second and third exemplary embodiments.

The clamping body 25 according to the fourth exemplary embodiment is a body that is rigid in itself and is not nonrigid. The clamping body 25 may be especially a steel body. It has a regular cylindrical shape and has a solid cross section. The opposite surface 9, which again forms the bottom of the channel, also acts at the same time as a guide path for the clamping body 25, which is moved transversely as a whole during the clamping of the ends of the packing 2, 3, because the clamping body 25 performs a rolling and/or sliding movement away from the first opposite surface 4 and into the second opposite surface 5 during the introduction of the ends of the packing 2, 3.

The second opposite surface 5 is formed by a spring 15 that is elastic in its material. The spring 15 is an insert made of an elastic material, e.g., rubber or an elastomer, which is inserted into a depression of the channel wall 5. The depression and the insert 15 are shaped such that the insert 15 fits seamlessly into the flat channel wall 5 and, in particular, ends flat with same, forming the opposite surface 5. In the exemplary embodiment, the insert 15 is a strip, which extends over at least part of the axial length of the channel 6 that the clamping body 25 or the plurality of clamping bodies 25 arranged axially next to each other occupies/occupy. The insert 15 has a rectangular cross section and is a parallelepiped as a whole in the exemplary embodiment. It has a thickness and a width, measured along the channel wall 5, which are sufficient to allow the insert 15 to perform an inward spring excursion to the extent that the clamping body 25 can move along the opposite surface 9 away from the first opposite surface 4 by the thicknesses of the two ends of the packing 2, 3. The elastic restoring force of the insert 15 presses the clamping body 25 against the ends of the packing 2, 3 with the packing 2, 3 pulled in. The displacement of the clamping body 25 is indicated by a straight line that is parallel to the radial R of the cylinder. The displaced center of gravity is designated by SP.

The formation of the spring 15 in one of the walls of the channel 6 is advantageous for the rotatability of the clamping body 25, and this rotatability is in turn advantageous for the pulling in and the removal of the ends of the packing 2, 3. Furthermore, the clamping body 25 may have an advantageously heavy weight and, finally, its manufacture is especially simple.

The filler 8 forms the carrier for the insert 15. The spring can therefore be created by means of the insert 15 in an especially simple manner.

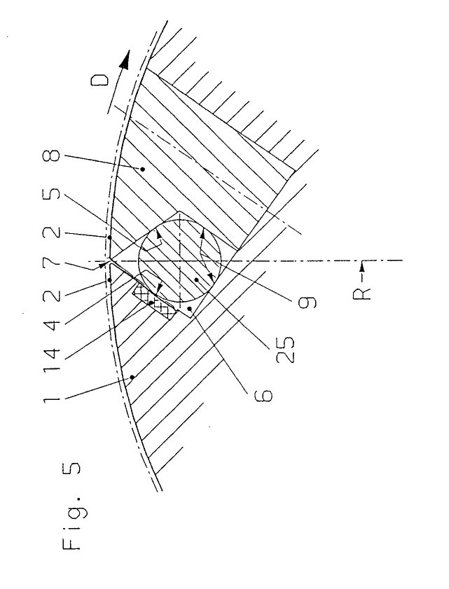

FIG. 5 shows a clamping device according to a fifth exemplary embodiment, which is derived from that according to the fourth exemplary embodiment. The first opposite surface 4 forming the clamping gap with the clamping body 25 is formed by an insert 14 in the fifth exemplary embodiment. The insert 14 corresponds to the insert 15 according to the fourth exemplary embodiment. The two exemplary embodiments according to FIGS. 4 and 5 show, furthermore, in their combination that the clamping devices according to the two exemplary embodiments are also already inherently invariant with respect to the direction of rotation, i.e., the ends of the packing 2, 3 can be clamped between the clamping body 25 and either the first opposite surface 4 or the second opposite surface 5 as desired in both exemplary embodiments.

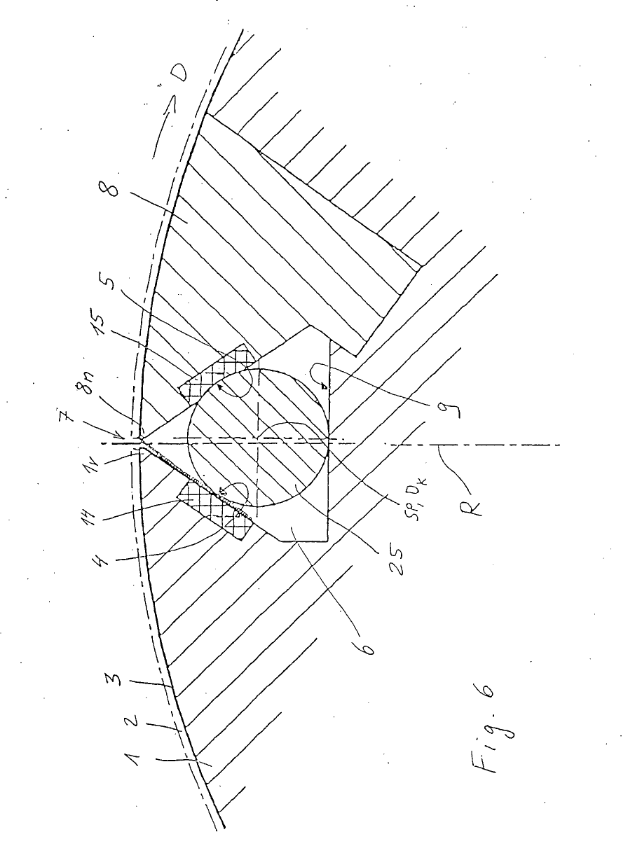

A sixth exemplary embodiment derived from the fourth and fifth exemplary embodiments is shown in FIG. 6. In the sixth exemplary embodiment, the first opposite surface 4 is formed by an insert 14 that is elastic in its material, and the second opposite surface 5 is formed by another insert 15, which is elastic in its material. The statements made in connection with the fourth exemplary embodiment apply to both the spring formed by means of the insert 14 and the spring formed by means of the insert 15. As a result, a clamping device that is invariant with respect to the direction of rotation is obtained without making concessions. To facilitate the manufacture, an additional filler could form the channel wall 4 or at least a part forming the insert 14 and thus act as a carrier for the insert 14.

Even though it would also be possible to form the spring in or at a bottom surface turned outwardly, e.g., on the opposite surface 9, when forming the spring in or at one of the channel walls limiting the channel 6, the spring or the plurality of springs is/are preferably formed at channel walls that point toward the inside of the cylinder. The forces of elasticity generated by such springs, which forces generate the total clamping force with the cylinder not rotating and a large part of the clamping force with the cylinder rotating at a low speed, are directed toward the inside of the cylinder and thus they not only clamp the ends of the packing 2, 3 but also tension them toward the inside of the channel.

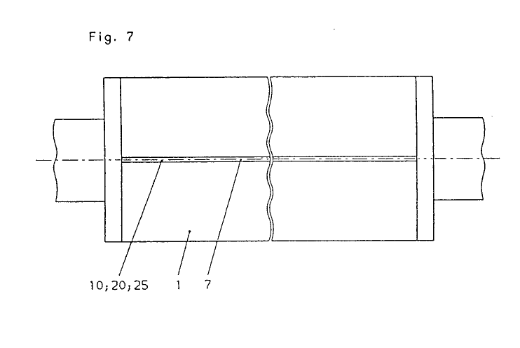

FIG. 7 shows a view of a part of the cylinder 1 including the channel 6. A single clamping body, either the clamping body 10, 20 or 25, is arranged in the channel 6.

While specific embodiments of the invention have been shown and described in detail to illustrate the application of the principles of the invention, it will be understood that the invention may be embodied otherwise without departing from such principles.

1. A clamping device for clamping a flexible packing of a cylinder of a printing press, which said cylinder has an axial channel on a jacket surface, said clamping device comprising:
a clamping body, which forms a clamping gap in said clamping channel with a first opposite surface for at least one end of said packing, which said end protrudes through said opening of said channel;
two said channel walls, which face said first opposite surface, and one of which forms a second opposite surface and the other forms a third opposite surface, on which said clamping body is supported, touching it;
wherein at least one said clamping body and said opposite surfaces form a spring, and the force of elasticity of said spring tensions said clamping body and said first opposite surface toward each other in order to clamp the at least one end of said packing with said packing pulled in.

2. A clamping device in accordance with claim 1, wherein said opposite surfaces are formed on one or both of said cylinder or on a filler immovably bound with said cylinder.

3. A clamping device in accordance with claim 1, wherein said opposite surfaces form support points for said clamping body, which are distributed around the circumference of said clamping body, wherein two adjacent support points each have an angular distance of less than 180°.

4. A clamping device in accordance with claim 1, wherein that wherein the at least one end of said packing is introduced into the clamping gap against the force of elasticity of said spring.

5. A clamping device in accordance with at least claim 1, wherein said spring can be caused to perform an inward spring deflection by the thickness of the at least one end of said packing.

6. A clamping device in accordance with claim 1, wherein said clamping body forms said spring.

7. A clamping device in accordance with claim 6, wherein said clamping body is elastic in its material.

8. A clamping device in accordance with claim 7, wherein said clamping body is a composite body with a core made of a core material and with a coating (10a) made of an elastically nonrigid coating material, which is connected to said core and has a lower specific gravity than the core material and which can be caused to perform an inward spring deflection by the thickness of the at least one end of said packing.

9. A clamping device in accordance with claim 8, wherein said coating envelopes said core.

10. A clamping device in accordance with claim 8, wherein the coating material has a Shore hardness of 70 Shore±10 Shore.

11. A clamping device in accordance with claim 6, wherein said clamping body is elastic due to its shape.

12. A clamping device in accordance with claim 11, wherein said clamping body forms a elastic arc and forms said clamping gap with said arc, and that said arc is open.

13. A clamping device in accordance with claim 12, wherein said arc extends over at least two of said opposite surfaces and is elastically tensioned to at least two of said opposite surfaces.

14. A clamping device in accordance with claim 12, wherein said arc forms said support feet at its two ends, with which it is supported in said channel and between which it is elastically tensioned.

15. A clamping device in accordance with claim 1, wherein an insert, which is inserted into a channel wall limiting said channel, or an elastically nonrigid coating, which is arranged on said channel wall, forms said spring.

16. A clamping device in accordance with claim 15, wherein said insert is elastic in its material.

17. A clamping device in accordance with claim 16, wherein said insert has a Shore hardness of 70 Shore±10 Shore.

18. A clamping device in accordance with claim 16, wherein said insert or said coating is provided with a wear-resistant surface, preferably coated with a harder material forming the wear-resistant surface, on a side facing said clamping body.

19. A clamping device in accordance with claim 1, wherein at least two of said opposite surfaces are formed by an insert or coating that is elastic in its material.

20. A clamping device in accordance with claim 1, wherein a recess, which is formed on the jacket surface of said cylinder, and at least one said filler inserted into said recess form said channel and said limiting edges of said opening of said channel, and said filler is provided with a insert or a coating that is elastic in its material.

21. A clamping device in accordance with claim 1, wherein said opening of said channel is limited by two said limiting edges in the circumferential direction of said cylinder that said channel widens from said limiting edges in both circumferential directions of said cylinder; and that a channel wall extending up to one of said limiting edges forms said first opposite surface, and a channel wall extending up to the other of said limiting edges forms said second opposite surface, so that the at least one end of said packing can be clamped between said clamping body and either said first opposite surface or said second opposite surface depending on said direction of rotation (D) of said cylinder.

22. A clamping device in accordance with claim 1, wherein said first opposite surface points at an angle of at least 30° to a radial (R) extending through said channel opening toward said axis of rotation (D_{Z}) of said cylinder.

23. A clamping device in accordance with claim 1, wherein said second opposite surface points at an angle of at least 30° toward a radial (R) extending through said channel opening toward said axis of rotation (D_{Z}) of said cylinder.

24. A clamping device in accordance with claim 1, wherein one of said opposite surfaces forms a guide path, along which said clamping body can be moved in a rolling and/or sliding manner at right angles to said axis of rotation (D_{Z}) of said cylinder.

25. A clamping device in accordance with claim 1, wherein said clamping body has a round surface, with which it forms the clamping gap, at least in the nonloaded state.

26. A clamping device in accordance with claim 1, wherein the round surface has a radius of curvature that is greater than 7 mm and preferably greater than 10 mm.

27. A clamping device in accordance with claim 1, wherein said clamping body is rotatable in said channel while the clamping gap is maintained.

28. A clamping device in accordance with claim 1, wherein a plurality of said packings are tensioned onto said cylinder, arranged axially next to one another, and not more than one said clamping body per packing is provided.

29. A clamping device in accordance with claim 1, wherein only one said clamping body is arranged in said channel.

30. A clamping device in accordance with claim 1, wherein a plurality of said separate clamping bodies are arranged in said channel.
